(19) United States
(12) Patent Application Publication
(10) Pub. No.: US 2024/0301958 A1
(43) Pub. Date: Sep. 12, 2024

(54) SEAL AND FLUID VALVE HAVING SUCH A SEAL

(71) Applicant: Vitesco Technologies GmbH, Regensburg (DE)

(72) Inventors: Chunxiao Yan, Haimen (CN); Jörg Eissler, Wiesbaden (DE); Prashant Chavan, Waldsolms-Brandoberndorf (DE)

(73) Assignee: Vitesco Technologies GmbH, Regensburg (DE)

(21) Appl. No.: 18/665,911

(22) Filed: May 16, 2024

Related U.S. Application Data
(63) Continuation of application No. PCT/EP2022/081933, filed on Nov. 15, 2022.

(30) Foreign Application Priority Data
Nov. 23, 2021 (DE) 10 2021 213 188.3

(51) Int. Cl. F16K 5/04

(52) U.S. Cl. CPC F16K 5/0471

(57) ABSTRACT

A seal for use in a fluid valve, or multi-path fluid valve, has a cylindrical, resilient base member, a plurality of first sealing portions arranged at an outer side of the base member for sealing abutment against a valve housing of the fluid valve, and a plurality of second sealing portions, arranged at an inner side of the base member, for sealing abutment against an adjustable valve body of the fluid valve. A respective first sealing portion and respective second sealing portion are arranged circumferentially around a respective sealing opening of the base member. There is arranged at the inner side of the base member a first layer having a sliding friction coefficient which is less with respect to the valve body and/or static friction coefficient which is less than the base member, and which is at least partially in contact with the valve body during use of the seal.

### CROSS-REFERENCE TO RELATED APPLICATIONS

This application claims priority to PCT Application PCT/EP2022/081933, filed Nov. 15, 2022, which claims priority to German Patent Application No. DE 10 2021 2013 188.3, filed Nov. 23, 2021. The disclosures of the above applications are incorporated herein by reference.

### FIELD OF THE INVENTION

The present invention relates to a seal for use in a fluid valve, a fluid valve having such a seal and a method for mounting the fluid valve.

### BACKGROUND OF THE INVENTION

The term “fluid valve” is intended to be understood in this case to be a cooling water control valve for use in a vehicle. The term “vehicle” is intended to be understood in this case to be any type of vehicle which has to be supplied with a liquid and/or gaseous fuel for operation, such as passenger motor vehicles and/or utility vehicles. Furthermore, the vehicle may also be a partially electric or fully electric vehicle, such as passenger motor vehicles and/or utility vehicles.

Seals as such can have different roles. They can, for example, serve to prevent or at least to limit undesired fluid losses. A fluid can be understood here as meaning a liquid and/or gaseous medium.

### SUMMARY OF THE INVENTION

An object of an embodiment of the present invention is to provide a seal for use in different fluid valves with a different number of valve connections. In this case, the seal is intended to be able to be produced in a cost-effective manner and to allow a tolerance compensation over a wide tolerance range. It is also an object of the invention to provide a fluid valve having such a seal.

This object is achieved by a seal having the features described. Also described is a method for mounting the fluid valve, a fluid valve and the use of the fluid valve.

According to an embodiment of the present invention, a seal for use in a fluid valve, such as a multi-path fluid valve, has a or at least one cylindrical, resilient base member, a plurality of first sealing portions which are arranged at an outer side of the base member for sealing abutment, such as statically sealing abutment, against a valve housing of the fluid valve, and a plurality of second sealing portions, which are arranged at an inner side of the base member, for sealing abutment, such as dynamically sealing abutment, against an adjustable valve body of the fluid valve, wherein a respective first sealing portion and a respective second sealing portion are arranged circumferentially around a respective sealing opening of the base member, and there is arranged at the inner side of the base member a first layer which has a sliding friction coefficient which is less with respect to the valve body and/or static friction coefficient which is less than the base member, and which is at least partially in contact with the valve body during correct use of the seal.

In one embodiment, since the base member of the seal contains a plurality of sealing openings which may each correspond to one of a plurality of valve connections, the seal may thereby be used in different fluid valves with a different number of valve connections. Furthermore, in one embodiment, since the first layer which has a sliding friction coefficient which is less with respect to the valve body and/or a static friction coefficient which is less than the base member is arranged on the inner side of the base member, and which is at least partially in contact with the valve body during correct use of the seal, friction between the base member or the first layer which is arranged thereon and the valve body during operation of the fluid valve is reduced and consequently wear of the valve is reduced.

In one embodiment, the base member is formed from an elastomer material, for example, ethylene-propylene-diene-rubber (EPDM) or has it. In this instance, in one embodiment, for example, the first layer may be in the form of a film or be applied by a coating method to a corresponding portion of the inner side of the base member. Furthermore, in one embodiment, an axial orientation of the cylindrical base member is parallel with a rotation axis of the adjustable valve body.

In one embodiment, the second sealing portions have a respective second layer which has a sliding friction coefficient which is less with respect to the valve body and/or static friction coefficient which is less than the base member and which is at least partially in contact with the valve body during correct use of the seal depending on a position of the valve body.

In one embodiment, the friction between the base member or the respective second layer of the second sealing portions and the valve body may thereby be further reduced during operation of the fluid valve and consequently the wear of the valve is further reduced. In one embodiment, for example, the second layer may be in the form of a film or be applied by a coating method to a corresponding portion of the inner side of the base member. In this instance, in one embodiment, the first layer and the second layer may be formed from the same material.

In one embodiment, the second sealing portions have second sealing lips, such as flexible second sealing lips, which extend radially inwardly from the base member and on which there is arranged the respective second layer which is at least partially in contact with a surrounding region of a valve body opening of an internal fluid channel of the valve body during correct use of the seal depending on the position of the valve body.

In one embodiment, a sealing between the seal and the valve body may thereby be improved.

In one embodiment, a respective first sealing portion and a respective second sealing portion form a respective pair of sealing portions, wherein the first sealing portion and the second sealing portion of a respective pair of sealing portions are provided to seal, during correct use of the seal, a respective fluid path between a respective valve housing opening of the valve housing and the valve body opening of the internal fluid channel of the valve body.

In one embodiment, at least two pairs of sealing portions are arranged with spacing from each other in the axial direction of the base member, such as a cylindrical base member.

In one embodiment, it is thereby possible to use the seal for a fluid valve which has a plurality of valve housing openings, which are arranged with spacing from each other in the axial direction of the base member, for connecting the fluid valve to a plurality of external valve connections.

In one embodiment, the inner side of the base member has at least one bellows-like portion, or a bellows portion, which extends in particular in the axial direction of the base member and which bears against it depending on the position of the valve body.

In one embodiment, the tolerance range for a difference between a diameter of the cylindrical base member and a diameter of a (similarly cylindrical) valve housing may thereby be increased.

In one embodiment, the first sealing portions are in the form of first sealing lips which extend radially outwardly away from the base member and which are in contact with the valve housing during correct use of the seal.

In one embodiment, it is thereby possible to further increase the tolerance range for the difference between the diameter of the cylindrical base member and the diameter of the (similarly cylindrical) valve housing.

In one embodiment, there is arranged on a front side of the base member a circumferential sealing ring which extends radially outwardly from the outer side of the base member and which, during correct use of the seal, is arranged between the valve housing and a cover of the fluid valve.

In one embodiment, it is thereby possible to seal an interior of the fluid valve statically with respect to an exterior of the fluid valve by the sealing ring.

A method for mounting a fluid valve, such as a multi-path fluid valve, has according to one embodiment of the invention the following steps:
a) providing a valve housing with a plurality of valve housing openings,
b) providing an above-described seal with a cylindrical, resilient base member having a plurality of sealing openings,
c) providing an adjustable valve body,
d) inserting the seal into the valve housing in such a manner that a respective one of the plurality of valve housing openings overlaps with a respective one of the plurality of sealing openings, and
e) inserting the adjustable valve body into the base member.

In one embodiment, it is thereby possible to simplify the mounting of the fluid valve since only a single seal for a fluid valve having a plurality of valve housing openings is required. In one embodiment, the assembly costs may thereby also be reduced.

In one embodiment, in the method in step a) a cylindrical valve housing is provided, in step b) a seal having a base member is provided, on the front side of which a circumferential sealing ring is arranged, and in step d) the seal is inserted into the valve housing in such a manner that the circumferential sealing ring is positioned on a front side of the valve housing, wherein the method further has the steps of:
f) providing a cover of the fluid valve,
g) arranging the cover in such a manner on the front side of the valve housing that the circumferential sealing ring is arranged between the cover and the front side of the valve housing, and
h) securing the cover to the valve housing.

In one embodiment, a static seal of an interior of the fluid valve with respect to an exterior of the fluid valve is thereby achieved.

A fluid valve for sealing a respective fluid path between a respective valve housing opening and a respective valve body opening of an internal fluid channel of a valve body has according to one embodiment of the invention at least one above-described seal, a valve housing with a plurality of valve housing openings and an adjustable valve body.

In one embodiment, the above-described fluid valve is in the form of a multi-path fluid valve.

According to one embodiment of the invention, an above-described fluid valve is used as a cooling water control valve.

According to one embodiment of the invention, an above-described fluid valve is used as a cooling water control valve of a vehicle.

### BRIEF DESCRIPTION OF THE DRAWINGS

Further advantages and features can be found in the exemplary embodiments. In this respect, shown in part schematically:

FIG. 1 shows a cross sectional view of a fluid valve having a seal according to an embodiment of the present invention;

FIG. 2 shows a seal according to an embodiment of the invention;

FIG. 3 shows a valve body of the fluid valve;

FIG. 4 shows a cross sectional view of a valve housing of a fluid valve with a seal arranged therein; and

FIG. 5 shows a flow chart for depicting a method for mounting a fluid valve, such as a multi-path fluid valve according to an embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

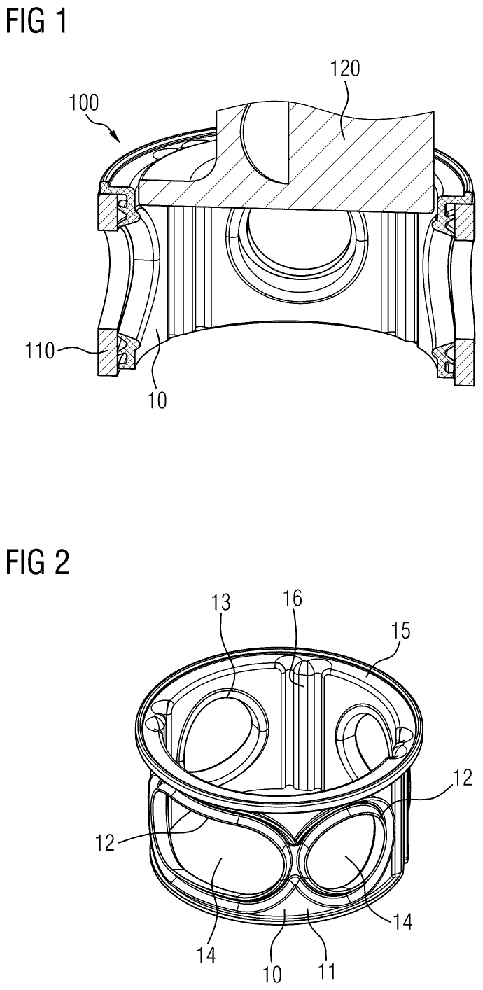

FIG. 1 shows a fluid valve 100 having a seal according to an embodiment of the present invention.

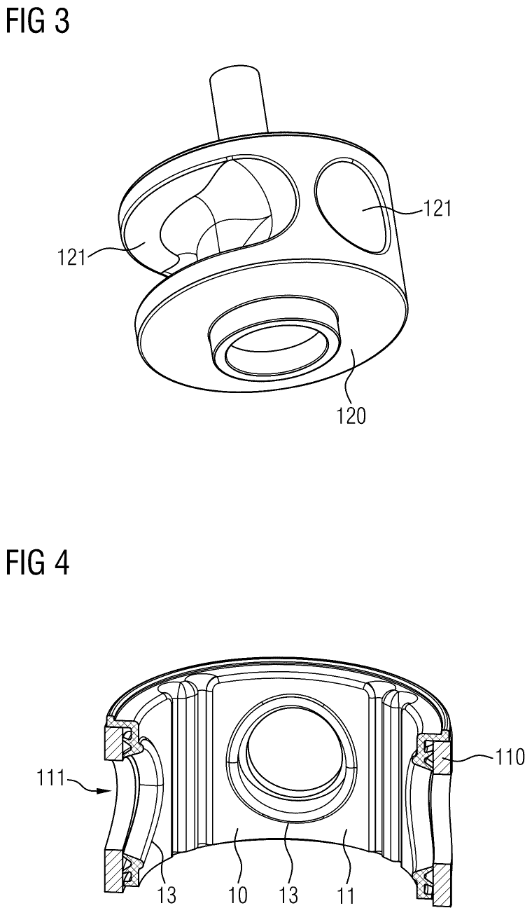

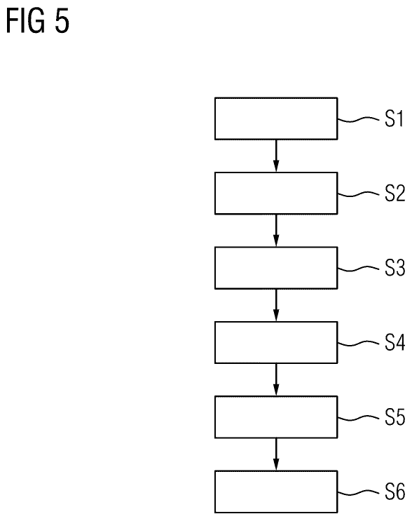

The fluid valve 100, such as a multi-path fluid valve, has a valve housing 110, which in an embodiment is a cylindrical valve housing, in which a seal 10 which is shown as a perspective view in FIG. 2 is arranged. The seal 10 has a cylindrical base member 11 which is formed from a resilient material, such as an elastomer material, for example, an ethylene-propylene-diene rubber (EPDM) or has it, and in which an adjustable valve body 120 of the fluid valve 100 which is shown as a perspective view in FIG. 3 is arranged.

The seal 10 has a plurality of first sealing portions 12, which are arranged at an outer side of the base member 11, for sealing abutment, such as statically sealing abutment, against the valve housing 110 of the fluid valve 100, and a plurality of second sealing portions 13, which are arranged at an inner side of the base member 11, for sealing abutment, such as dynamically sealing abutment, against the adjustable valve body 120 of the fluid valve 100.

In this instance, a respective first sealing portion 12 and a respective second sealing portion 13 are arranged circumferentially around a respective sealing opening 14 of the base member 11. At the inner side of the base member 11, there is arranged a first layer which is not shown and which has a sliding friction coefficient which is less with respect to the valve body 120 and/or static friction coefficient which is less than the base member 11, and which is at least partially in contact with the valve body 120. The first layer is, for example, in the form of a film or is applied by a coating method to a corresponding portion of the inner side of the base member 11. Furthermore, an axial orientation of the cylindrical base member 11 is parallel with a rotation axis of the adjustable valve body 120.

The second sealing portions 13 have a respective second layer which is not shown and which has a sliding friction coefficient which is less with respect to the valve body 120 and/or static friction coefficient which is less than the base member 11, and which is at least partially in contact with the valve body 120 depending on a position of the valve body 120. The second layer may, for example, be in the form of a film or be applied by a coating method to a corresponding portion of the inner side of the base member 11. In this instance, the first layer and the second layer may be formed from the same material.

The second sealing portions 13 have second sealing lips, such as flexible second sealing lips, which extend radially inwardly from the base member 11 and on which there is arranged the second layer which is at least partially in contact with a surrounding region of a valve body opening 121 of an internal fluid channel of the valve body 120 depending on the position of the valve body 120.

In this instance, a respective first sealing portion 12 and a respective second sealing portion 13 form a respective pair of sealing portions, wherein the first sealing portion 12 and the second sealing portion 13 of a respective pair of sealing portions are provided to seal a respective fluid path between a respective valve housing opening 111 of the valve housing 110 and the valve body opening 121 of the internal fluid channel of the valve body 120.

In an embodiment which is not shown, at least two pairs of sealing portions are arranged with spacing from each other in the axial direction of the base member 11, which in an embodiment may be a cylindrical base member.

The inner side of the base member 11 has, as depicted in FIG. 2, at least one bellows-like portion 16, such as a bellows portion, which extends in the axial direction of the base member 11 and which bears against it depending on a position of the valve body 120.

The first sealing portions 12 are in the form of first sealing lips which extend radially outwardly away from the base member 11 and which are in contact with the valve housing 110.

There is arranged at a front side of the base member 11 a circumferential sealing ring 15 which extends radially outwardly from the outer side of the base member 11 and which is arranged between the valve housing 110 and a cover (not shown) of the fluid valve 100.

FIG. 5 shows a flow chart for depicting a method for mounting a fluid valve, such as a multi-path fluid valve, according to one embodiment of the invention.

Initially, in step S1, a valve housing 110, such as the cylindrical valve housing 110 of a fluid valve 100 with a plurality of valve housing openings 11 is provided.

In step S2, a seal 10 having a cylindrical resilient base member 11 with a plurality of sealing openings 14 is provided, on the front side of which a circumferential sealing ring 15 is arranged.

In step S3, an adjustable valve body 120 is provided.

In step S4, the seal 10 is inserted into the valve housing 110 in such a manner that a respective one of the plurality of valve housing openings 111 overlaps with a respective one of the plurality of sealing openings 14 and the circumferential sealing ring 15 is positioned on a front side of the valve housing 110.

In step S5, the adjustable valve body 120 is inserted into the base member 11.

In step S6, a cover of the fluid valve 100 is provided, the cover is arranged on the front side of the valve housing 110 in such a manner that the circumferential sealing ring 15 is arranged between the cover and the front side of the valve housing, and the cover is secured to the valve housing 110.

The description of the invention is merely exemplary in nature and, thus, variations that do not depart from the gist of the invention are intended to be within the scope of the invention. Such variations are not to be regarded as a departure from the spirit and scope of the invention.

### LIST OF REFERENCE SIGNS

10 Seal
11 Main body
12 First sealing portions
13 Second sealing portions
14 Sealing opening of the base member
15 Circumferential sealing ring
16 Bellows-like portion
100 Fluid valve
110 Valve housing
111 Valve housing opening
120 Valve body
121 Valve body opening

What is claimed is:

1. A seal for use in a fluid valve, or multi-path fluid valve, having:
a cylindrical, resilient base member;
a plurality of sealing openings being part of the base member;
a plurality of first sealing portions which are arranged at an outer side of the base member for sealing abutment against a valve housing of the fluid valve, each of the plurality of first sealing portions are arranged circumferentially around a respective sealing opening of the base member;
a plurality of second sealing portions, which are arranged at an inner side of the base member, for sealing abutment against an adjustable valve body of the fluid valve, each of the plurality of second sealing portion are arranged circumferentially around a respective sealing opening of the base member; and
a first layer arranged at the inner side of the base member, the first layer at least partially in contact with the valve body during use of the seal;
wherein the first layer has a sliding friction coefficient which is less with respect to the valve body and/or static friction coefficient which is less than the base member.

2. The seal of claim 1, each of the plurality of second sealing portions further comprising:
a respective second layer at least partially in contact with the valve body during use of the seal, depending on a position of the valve body;
wherein the second layer has a sliding friction coefficient which is less with respect to the valve body and/or static friction coefficient which is less than the base member.

3. The seal of claim 2, each of the plurality of second sealing portions further comprising:
a plurality of sealing lips which extend radially inwardly from the base member, the respective second layer arranged on the plurality of sealing lips;
wherein the second layer is at least partially in contact with a surrounding region of a valve body opening of an internal fluid channel of the valve body during use of the seal depending on the position of the valve body.

4. The seal of claim 3, further comprising:
at least one pair of sealing portions further comprising one of the plurality of first sealing portions and one of the plurality of second sealing portions;
wherein the at least one pair of sealing portions are provided to seal, during use of the seal, a respective fluid path between a respective valve housing opening of the valve housing and the valve body opening of the internal fluid channel of the valve body.

5. The seal of claim 4, wherein at least two pairs of sealing portions are arranged with spacing from each other in an axial direction of the base member.

6. The seal of claim 5, the inner side of the base member further comprising at least one bellows-like portion, or bellows portion, which extends in the axial direction of the base member and which bears against the base member, depending on the position of the valve body.

7. The seal of claim 1, the first sealing portions further comprising:
a plurality of sealing lips which extend radially outwardly away from the base member and which are in contact with the valve housing during use of the seal.

8. The seal of claim 1, further comprising:
a circumferential sealing ring arranged on a front side of the base member;
wherein the circumferential sealing ring extends radially outwardly from the outer side of the base member and which, during use of the seal, is arranged between the valve housing and a cover of the fluid valve.

9. A method for mounting a fluid valve, or multi-path fluid valve, having the steps of:
a) providing a valve housing having a plurality of valve housing openings;
b) providing a seal with a cylindrical, resilient base member having a plurality of sealing openings;
c) providing an adjustable valve body;
d) inserting the seal into the valve housing in such a manner that a respective one of the plurality of valve housing openings overlaps with a respective one of the plurality of sealing openings; and
e) inserting the adjustable valve body into the base member.

10. The method of claim 9, further comprising the steps of:
in step a) a cylindrical valve housing is provided;
in step b) a seal having the base member is provided, on the front side of which a circumferential sealing ring is arranged;
in step d) the seal is inserted into the valve housing in such a manner that the circumferential sealing ring is positioned on a front side of the valve housing, wherein the method further has the steps of:

11. The method of claim 10, further comprising the steps of:
f) providing a cover of the fluid valve;
g) arranging the cover in such a manner on the front side of the valve housing that the circumferential sealing ring is arranged between the cover and the front side of the valve housing; and
h) securing the cover to the valve housing.

12. A fluid valve comprising:
at least one seal further comprising:
a cylindrical, resilient base member;
a plurality of sealing openings being part of the base member;
a plurality of first sealing portions which are arranged at an outer side of the base member for sealing abutment against a valve housing of the fluid valve, each of the plurality of first sealing portions are arranged circumferentially around a respective sealing opening of the base member;
a plurality of second sealing portions, which are arranged at an inner side of the base member, for sealing abutment against an adjustable valve body of the fluid valve, each of the plurality of second sealing portion are arranged circumferentially around a respective sealing opening of the base member;
a first layer arranged at the inner side of the base member, the first layer at least partially in contact with the valve body during use of the seal;
wherein the first layer has a sliding friction coefficient which is less with respect to the valve body and/or static friction coefficient which is less than the base member;
a valve housing with a plurality of valve housing openings; and
an adjustable valve body for sealing a respective fluid path between a respective valve housing opening and a respective valve body opening of an internal fluid channel of the valve body.

13. The fluid valve of claim 12, the fluid valve further comprising a multi-path fluid valve.

14. The fluid valve of claim 12, wherein the fluid valve is a cooling water control valve.

15. The fluid valve of claim 12, wherein the fluid valve is a cooling water control valve of a vehicle.
